(19) United States
(12) Patent Application Publication
(10) Pub. No.: US 2023/0214980 A1
(43) Pub. Date: Jul. 6, 2023

(54) Method for checking a static monitoring system installed in a traffic space, and static monitoring system

(71) Applicant: Continental Automotive Technologies GmbH, Hannover (DE)

(72) Inventors: Michael Goldhammer, Haibach (DE); Peter Quittenbaum, Bad Vilbel (DE); Alexander Sauermann, Alzenau (DE)

(73) Assignee: Continental Automotive Technologies GmbH, Hannover (DE)

(21) Appl. No.: 18/150,225

(22) Filed: Jan. 5, 2023

(30) Foreign Application Priority Data
Jan. 5, 2022 (DE) 10 2022 200 073.0

(51) Int. Cl. G06T 7/00; G06T 7/73

(52) U.S. Cl. CPC G06T 7/0002; G06T 7/74; G06T 2207/30232; G06T 2207/30236; G06T 2207/30244

(57) ABSTRACT

A method of inspecting a static monitoring installation including creating a reference image from signal reflections from static objects in a monitoring space determining a reference value from the reflections of the reference image, creating a comparison image from the signal reflections from the static objects in the space, wherein the comparison image is recorded with a time offset after the reference image, determining at least one comparison value from the reflections of the comparison image, and outputting a fault signal when a deviation of the comparison value and the reference value exceeds a threshold value.

### CROSS-REFERENCE TO RELATED APPLICATIONS

The present application claims priority from German Patent Application No. 10 2022 200 073.0 filed on Jan. 5, 2022, in the German Patent and Trade Mark Office, the content of which is herein incorporated by reference in its entirety.

### BACKGROUND

### 1. Field

Embodiments of the present application relate to a method for inspecting a static monitoring installation, installed in a traffic space and comprising a signal transmitter for transmitting a signal and a signal receiver that is able to receive the signal from the signal transmitter reflected from an object, and comprising an evaluation circuit that is able to create an image of the environment from the received signal.

### 2. Description of Related Art

Static monitoring installations are used to monitor areas of traffic or the traffic in the areas of traffic. The results of the monitoring may be used for example to control flows of traffic or individual vehicles.

Systems consisting of a signal transmitter and a signal receiver are used for the monitoring, for example. The signal transmitted by the signal transmitter is reflected from objects and may be received by the signal receiver. The type and the direction of the reflection and the signal strength of the reflected signal may be used to determine the position of objects and thus to create an image of the environment.

Moving objects are recognized for example by detecting changes in the images of the environment that are created from the reflected signals or changes in the signal (time of flight, frequency. etc.).

After the monitoring installation has been installed, the monitoring installation or the sensor may move or rotate, which may distort the measurement results of the system.

### SUMMARY

According to an aspect of an embodiment, there is provided a method for inspecting a static monitoring installation, which method enables recognition of pivoting of the sensor or of the monitoring installation.

To achieve the aspect, provision is made for a method for inspecting a static monitoring installation installed in a traffic space, wherein the monitoring installation has a signal transmitter for transmitting a signal and a signal receiver that is able to receive the signal from the signal transmitter reflected from an object, and an evaluation circuit that is able to create an image of the environment from the received signal. The method comprises the following steps:
creating a reference image from the reflections from static objects in the space to be monitored by the monitoring installation;
ascertaining and storing at least one reference value from the reflections of the reference image, and then
creating a comparison image from the reflections from static objects in the space to be monitored by the monitoring installation, wherein the comparison image is recorded with a time offset after the reference image,
ascertaining at least one comparison value from the reflections of the comparison image,
comparing the comparison value with the reference value and outputting a fault signal when a deviation of the comparison value and the reference value exceeds at least one threshold value.

In the reference image, reference points or reference patterns are identified from multiple reference points that represent fixed objects. At least one reference value is ascertained from the data of these reference points or reference patterns, for example position or signal strength, and stored in the evaluation circuit.

During operation of the monitoring installation, comparison images depicting the current traffic scene are recorded constantly. In these comparison images, comparison points or comparison patterns corresponding to the reference points or the reference patterns, respectively, are identified. At least one comparison value is ascertained from these comparison points or comparison patterns, with this comparison value being ascertained in the same way or using the same method as the reference value.

If the position or the orientation of the monitoring installation and the position of the static objects in the monitoring area of the monitoring installation have not changed, the comparison value corresponds to the reference value or deviates only slightly therefrom. Slight or brief deviations are possible when individual static objects or individual reference points are concealed briefly by moving objects. A permanent deviation between the comparison value and the reference value indicates that the orientation of the monitoring installation has changed.

In order to avoid fluctuations when acquiring and ascertaining the comparison value, for example caused by temporary concealment of static objects, a threshold value is defined, the comparison value being allowed to deviate from the reference value by said threshold value.

If this threshold value is exceeded, a fault signal is output. By way of example, the fault signal is output to a superordinate controller that is able to perform an extensive diagnosis of the monitoring installation or is able to inform a maintenance service.

The reference points or reference patterns are combined to form a reference value, the comparison of this reference value with a threshold value offers the advantage that only the at least one reference value and the at least one comparison value need to be compared. A comparison between individual points or patterns, which would be linked to greater computing effort, is thus not necessary.

The reference image and the comparison image are preferably acquired and/or stored in a polar coordinate system grid, wherein in each case an angle, a distance and an intensity of each grid field of the polar coordinate grid are acquired and/or stored, wherein the intensity of the grid field is ascertained from the number and the intensity of the reflections of the respective grid field. Pivoting about a horizontal axis has a different effect, when acquiring the comparison pattern by way of polar coordinates, on the ascertainment of the comparison value than pivoting about a vertical axis. When acquiring the reference pattern in a polar coordinate system and subsequently ascertaining the comparison value, it is thus possible to detect the direction in which the monitoring installation was pivoted.

A first reference value and a first comparison value, which is compared with the first reference value, are formed for example from the distances and the intensities of the grid fields of the polar coordinate grid, wherein in particular a respective quotient is formed from the distances and the intensities of the grid fields of the polar coordinate grid.

Ascertaining the first reference value and the first comparison value may for example comprise in each case summing the distances and the intensities of the grid fields of the polar coordinate grid.

A second reference value and a second comparison value, which is compared with the second reference value, may be formed from the distances and the intensities of the grid fields of the polar coordinate grid, wherein in particular a respective quotient is formed from the angles and the intensities of the grid fields of the polar coordinate grid.

Pivoting about a horizontal axis, for example tilting, as may occur for example in the event of inadequate or defective installation, leads to the scanning area of the monitoring installation moving in the vertical direction, that is to say upwards or downwards. Since the scanning area is limited in the vertical direction, this leads to individual reference points and/or reference patterns dropping out of the scanning area of the monitoring installation, that is to say no longer being captured thereby. New reference points and/or reference points that are located in the newly added scanning area may also be added. Reference points and/or reference patterns that continue to lie in the scanning area are moved in the vertical direction, meaning that their position moves in the polar coordinate system.

Ascertaining the second reference value and the second comparison value may comprise in each case summing the angles and the intensities of the grid fields of the polar coordinate grid.

A defined starting value may be prescribed for the at least one threshold value. The threshold value is in this case defined such that a slight deviation of the comparison value from the reference value is possible. Such a slight deviation may for example arise when moving objects give rise to additional reflections or static objects are concealed, meaning that no reflections are able to be received therefrom. The threshold value is defined such that no fault signal is output in the event of such a deviation.

The at least one threshold value may also be adapted during operation of the monitoring installation, in particular on the basis of the ascertained deviation of the comparison value and the reference value. By way of example, a standard deviation of the comparison value from the reference value may be ascertained. Such a standard deviation may take into consideration usual fluctuations in the reflections, which may be caused by temporary concealment of individual static objects by moving objects. The standard deviation may for example be ascertained during ongoing operation. In the event of a small standard deviation, the threshold value may be reduced accordingly.

By way of example, the threshold value is calculated on the basis of the standard deviation, for example as a multiple of the standard deviation or of a value calculated from the standard deviation.

The reference image may for example be recorded beforehand, for example when the monitoring installation is installed.

The reference image may however also be adapted, in particular on the basis of the captured comparison images.

By way of example, reflections from static objects that occur repeatedly or each time a comparison image is recorded may be weighted with a learning factor that is stored with the reflection or the reference pattern that contains the reflections. In the event of reflections that do not occur repeatedly, an unlearning factor may additionally be subtracted, meaning that the reflections, if they do not occur briefly, are still taken into consideration, but are no longer taken into consideration after a defined time.

It is thereby possible to dynamically adapt the reference image, for example to construction measures or changed vegetation.

According to an aspect of an embodiment, there is provided a static monitoring installation that has an evaluation circuit that is able to inspect the monitoring installation using one of the methods described above.

### BRIEF DESCRIPTION OF THE DRAWINGS

Further advantages and features become apparent from the following description in connection with the appended drawings, in which:

FIG. 1 shows a schematic illustration of a monitoring installation;

FIG. 2 shows a schematic illustration of a reference image of the monitoring installation from FIG. 1;

FIG. 3 shows the reference image from FIG. 2 with a polar coordinate grid;

FIG. 4 shows an illustration of the reflections of the reference image from FIG. 2 in the polar coordinate grid;

FIG. 5 shows a schematic illustration of a comparison image with a restriction in the horizontal direction; and

FIG. 6 shows a schematic illustration of a comparison image with a restriction in the vertical direction.

### DETAILED DESCRIPTION

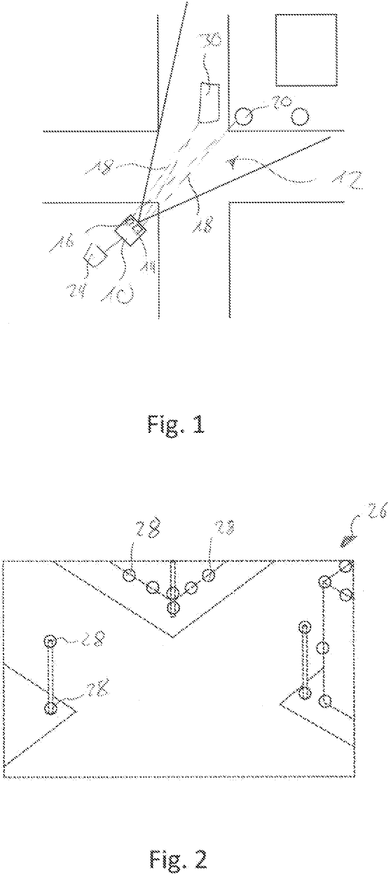

FIG. 1 shows a static monitoring installation 10 for a traffic space 12, in this example an intersection.

FIG. 1 shows only one monitoring installation 10. The traffic space 12 may however also contain multiple monitoring installations 10, for example in order to be able to monitor the traffic space 12 from different directions and/or perspectives. The monitoring installations 10 may be connected to one another or be connected to a common controller in order for example to compare the data from the monitoring installations 10 and/or to create a three-dimensional image of the traffic space 12.

The monitoring installation has a signal transmitter 14 and a signal receiver 16. The signal transmitter 14 transmits a signal 18, which is reflected from an object 20. The signal 18 is for example an optical, acoustic and/or electromagnetic signal. By way of example, the signal is a radar (radio detection and ranging) or lidar (light detection and ranging) signal.

If the signal 18 impacts an object 20, the signal 18 is reflected. The reflected signal 18 is detected by the signal receiver 16. The distance of the object 20 is able to be determined from the time of flight of the signal 18 from the signal transmitter 14 to the signal receiver 16. The direction of the object 20 is additionally able to be determined from the direction in which the signal 18 is transmitted and the direction from which the signal 18 is received by the signal receiver 16.

An image 26 of the traffic space 12 is able to be created in an evaluation circuit 24 from the received signals 22 or the direction and the distance of the objects 20. Each reflection may in this case be represented in this image 26 in simplified form by a point 28 (see FIG. 2).

The image 26 is constantly updated in order to recognize changes in the traffic space 12, for example moving objects 30 such as vehicles. By way of example, the signal transmitter 14 is pivoted or moved such that it captures the entire area to be monitored regularly or at a predefined frequency.

If a moving object 30 is located in the traffic space 12, this may be recognized through the fact that the reflections, that is to say the points 28 of this object in the image 26 change, for example change their position, or the time of flight and/or the frequency of the signal 22 increases or decreases.

Static objects, for example houses or traffic signs, on the other hand, provide a reflection of the signal 22 that is always the same, meaning that the points 28 that represent these static objects in the image 26 always remain unchanged.

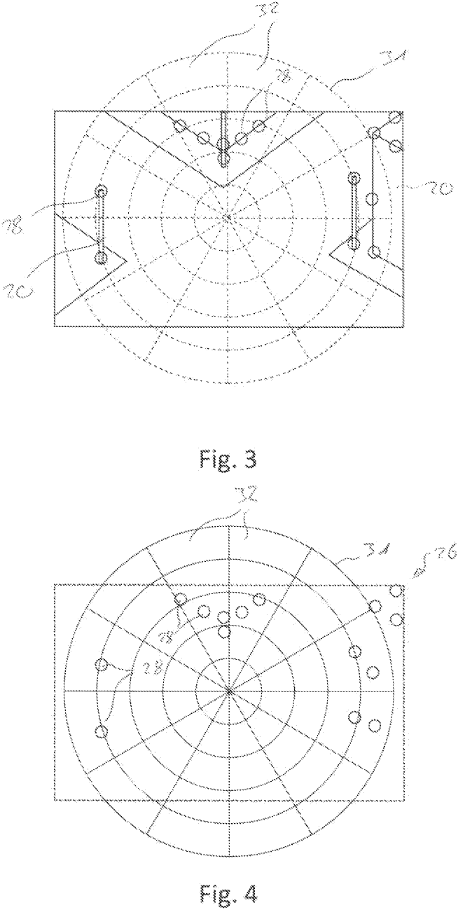

As may be seen in FIGS. 3 and 4, the monitoring area is divided into a polar coordinate grid. In other words, starting from an origin, the monitoring area 31 is divided into concentric rings that are divided equally into grid fields 32 in the circular direction.

These grid fields 32 may each be identified unambiguously by the distance from the origin and the angle with respect to a reference plane. In addition, an intensity is specified for each of these grid fields 32, this being dependent on the number of reflections within this grid field 32 and on the strength of these reflections. At least one reference value is ascertained from the data of the individual grid fields 32.

By way of example, a first reference value may be a graph or a quotient that is formed from the summed distances and the summed intensities of the individual grid fields 32.

A second reference value may be for example a graph or a quotient that is formed from the summed angles and the summed intensities of the individual grid fields 32.

These reference values are stored in the evaluation circuit.

During operation of the monitoring installation, a comparison image of the current state of the monitoring area is created from the current reflections and is updated constantly.

A first comparison value or a second comparison value is ascertained from the comparison images or the reflections of the comparison images, in the same way as the first reference value or the second reference value, respectively.

These comparison values are each compared with the corresponding reference value in order to recognize pivoting of the monitoring area about a vertical axis (movement about the azimuth angle) and/or about a horizontal axis (height angle).

By way of example, external influences may cause the monitoring installation to pivot or rotate about a vertical axis. Incorrect or defective attachment of the monitoring installation may for example lead to tilting of the monitoring installation, and thus to pivoting about a horizontal axis.

In order to detect pivoting about a vertical axis, the first comparison value is compared with the first reference value.

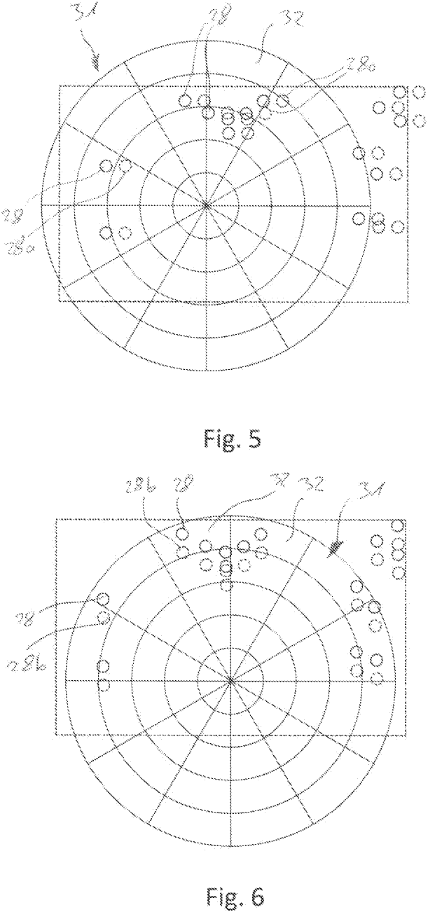

Pivoting of the monitoring installation about the vertical axis results in movement of the pattern from which the first comparison value or first reference value are ascertained (FIG. 5). For illustrative purposes, the original positions of the reflections 28b in the polar coordinate grid 32 are illustrated in dashes. The distances to the individual reference points or reference patterns thus also change in the polar coordinate system. The intensities in the individual grid fields of the polar coordinate grid are thereby also moved. This leads to the first comparison value being changed such that there is a large deviation from the first reference value.

If the deviation of the first reference value by the first reference value exceeds a first threshold value for the first reference value, a fault signal is output, in particular containing information about the fact that the first threshold value has been exceeded or that pivoting about a vertical axis has taken place.

Selecting the method for ascertaining the first reference value or the first comparison value appropriately may additionally make it possible to conclude as to the angle of the pivoting.

By way of example, the cumulative intensities of the reference image and of the comparison image may be plotted graphically against the azimuth angle. The residual sum of squares (RSS) of both curves may be used as indicator for the pivoting.

In order to detect pivoting of the monitoring installation about a horizontal axis, the second comparison value is compared with the second reference value.

In the event of tilting of the monitoring installation, that is to say pivoting about a horizontal axis, this does not result in movement of the static reflections from the static objects, since the distance and the azimuth angle of the monitoring installation relative to the static objects remain the same. The tilting however results in individual static reflections leaving the monitoring field of the sensor in the vertical direction or new reflections being added (FIG. 6).

This may be detected by comparing the second comparison value with the second reference value, since such a movement leads to a change in the position of the intensities in the polar coordinate system.

The residual sum of squares (RSS) of both curves may be likewise be used to acquire the angle of the pivoting.

The method described above offers a simple and reliable method for recognizing pivoting of the monitoring installation 10. Dividing the monitoring area into a polar coordinate grid in particular makes it possible to significantly reduce the amount of data and thus computing effort. By way of example, a polar coordinate grid comprises 200 azimuth sectors, 200 distance increments, and 8 bits for the intensity increments. This corresponds to a total of only 40 kB of memory.

1. A method of inspecting a static monitoring installation, the method comprising:
creating a reference image from signal reflections from static objects in a monitoring space monitored by the monitoring installation;
determining at least one reference value from the signal reflections of the reference image
creating a comparison image from the signal reflections from static objects in the monitoring space , wherein the comparison image is recorded with a time offset after the reference image;
determining at least one comparison value from signal reflections of the comparison mage; and
outputting a fault signal based on a deviation of the comparison value and the reference value exceeding threshold value.

2. The method according to claim 1, wherein the reference image and the comparison image are associated with a polar coordinate system grid,
wherein the polar coordinate grid system comprising a plurality of grid fields having an angle, a distance, and an intensity , and
wherein the intensity of the grid field is based on a number and an intensity of the reflections of the respective grid field.

3. The method according to claim 2, further comprising:
determining a first reference value and a first comparison value from the distances and the intensities of the grid fields of the polar coordinate grid; and
determining a respective quotient from the distances and the intensities of the grid fields of the polar coordinate grid.

4. The method according to claim 3, wherein determining the first reference value and determining the first comparison value comprises in each case summing the distances and the intensities of the grid fields of the polar coordinate grid.

5. The method according to claim 2, further comprising:
determing a second reference value and a second comparison value from the distances and the intensities of the grid fields of the polar coordinate grid; and
determining a respective quotient from the angles and the intensities of the grid fields of the polar coordinate grid.

6. The method according to claim 3, wherein determining the second reference value and determining the second comparison value comprises in each case summing the angles and the intensities of the grid fields of the polar coordinate grid.

7. (canceled)

8. The method according to claim 1, wherein the threshold value is adapted on the basis of the deviation of the comparison value and the reference value.

9. (canceled)

10. The method according to claim 1, wherein the reference image is adapted on the basis of the comparison image.

11. (canceled)
